(19) United States
(12) Patent Application Publication
(10) Pub. No.: US 2023/0301240 A1
(43) Pub. Date: Sep. 28, 2023

(54) A DRIVESHAFT AND AN OUTDOOR POWER EQUIPMENT COMPRISING SUCH DRIVESHAFT

(71) Applicant: HUSQVARNA AB, Huskvarna (SE)

(72) Inventors: Jeff Osterchill, Davidson, NC (US); Camden White, Huntersville, NC (US); Andrew Curtis, Charlotte, NC (US)

(21) Appl. No.: 18/020,744

(22) PCT Filed: Aug. 17, 2021
(86) PCT No.: PCT/SE2021/050797

§ 371 Date: Feb. 10, 2023

Related U.S. Application Data
(60) Provisional application No. 63/068,556, filed on Aug. 21, 2020.

(51) Int. Cl. A01G 3/08

(52) U.S. Cl. CPC A01G 3/086

(57) ABSTRACT

A driveshaft (130, 330) for outdoor power equipment (300) may include a power head interface assembly (340) configured to operably couple the driveshaft (130, 330) to a power head (110, 310) of the outdoor power equipment (300), an attachment interface assembly (342) configured to operably couple the driveshaft (130, 330) to a cutting attachment (120, 320) of the outdoor power equipment (300), an external casing rigidly coupling the power head interface assembly (340) to the attachment interface assembly (342), and a segmented internal drive assembly (360) configured to provide mechanical communication of mechanical power from the power head (110, 310) to the cutting attachment (120, 320). The segmented internal drive assembly (360) may include individually electrically insulated segments.

### TECHNICAL FIELD

Example embodiments generally relate to power equipment and, more particularly, relate to a pole saw with a non-conductive driveshaft.

### BACKGROUND

Property maintenance tasks are commonly performed using various tools and/or machines that are configured for the performance of corresponding specific tasks. Some of those tools, like chainsaws, are designed to be effective at felling trees or at cutting felled trees. However, sometimes operators may need or wish to cut individual branches at heights above the operator's head, or even outside the reach of the operator. Accordingly, pole saws have been developed to facilitate cutting in such situations. The pole saws may either be manually operated or powered.

In some cases, pole saws may be used in the vicinity of high voltage wires. Since a typical powered pole saw has a conductive mechanical connection between the powerhead and the cutting attachment, there could be a risk of shock if the operator accidentally contacts the high voltage wires. Thus, a manually operated pole saw would typically be used in such situations, and the manually operated pole saw would have a dielectric (e.g., insulated) construction.

### BRIEF SUMMARY OF SOME EXAMPLES

Some example embodiments may provide a powered pole saw with a dielectric construction. Thus, example embodiments may enable powered pole saw operation with confidence in safety in more use contexts.

In an example embodiment, a driveshaft for outdoor power equipment may be provided. The driveshaft may include a power head interface assembly configured to operably couple the outdoor power equipment, an external casing rigidly coupling the power head interface driveshaft to a power head of the outdoor power equipment, an attachment interface assembly configured to operably couple the driveshaft to a cutting attachment of the assembly to the attachment interface assembly, and a segmented internal drive assembly configured to provide mechanical communication of mechanical power from the power head to the cutting attachment. The segmented internal drive assembly may include individually electrically insulated segments.

In another example embodiment, an outdoor power equipment device may be provided. The device may include a power head, cutting attachment and driveshaft. The driveshaft may include a power head interface assembly configured to operably couple the driveshaft to a power head, an attachment interface assembly configured to operably couple the driveshaft to a cutting attachment, an external casing rigidly coupling the power head interface assembly to the attachment interface assembly, and a segmented internal drive assembly configured to provide mechanical communication of mechanical power from the power head to the cutting attachment. The segmented internal drive assembly may include individually electrically insulated segments.

Some example embodiments may improve the user experience, safety, and/or productivity during use of outdoor powered equipment.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1, which is defined by FIGS. 1A and 1B, illustrates a perspective view and side view, respectively, of a pole saw in accordance with an example embodiment;

FIG. 2, which is defined by FIGS. 2A, 2B and 2C, illustrates a perspective view of a driveshaft in isolation, various segments thereof, and a single segment in isolation, respectively, in accordance with an example embodiment;

FIG. 3, which is defined by FIGS. 3A and 3B, illustrates cross section views of the driveshaft in accordance with an example embodiment;

FIG. 4, which is defined by FIGS. 4A, 4B, 4C, 4D, 4E and 4F, illustrates various components of the driveshaft in accordance with an example embodiment; and

FIG. 5 is a block diagram of a device having a driveshaft in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other.

Some example embodiments may provide a powered pole saw that electrically isolates the power head from the cutting attachment via a dielectric driveshaft. In some example embodiments, not only may the driveshaft be dielectric, and therefore electrically insulated, but the driveshaft may further be made of segments that have bearing and/or bushing support between each respective segment. Furthermore, in some cases, the segments may be vented to allow the release of trapped gasses or pressure that may build up therein.

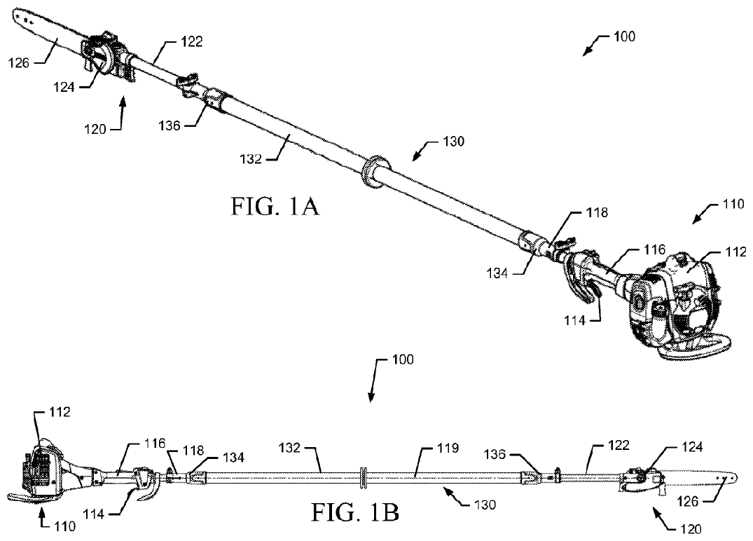

FIG. 1, which is defined by FIGS. 1A and 1B, illustrates an example embodiment being applied where the outdoor power equipment (e.g., pole saw 100) includes a power head 110 that is operably coupled (e.g., permanently or removably) to a cutting attachment 120 via a dielectric or insulated driveshaft 130. Although the power head 110 could take many different forms, the power head 110 of FIG. 1 includes a power source 112 (e.g., a battery powered, electric motor or a gasoline/petrol engine) that is operable responsive to actuation of a trigger 114 while the operators grasps handle 116. The power head 110 of this example may be operably coupled directly to the driveshaft 130 via a coupler 118. Although not shown, a spline portion (e.g., having a female fitting) may extend along a longitudinal axis 119 of the pole saw 100 into the coupler 118 in order to mate with a corresponding spline portion (e.g., having a male fitting) of the driveshaft 130. However, it should be appreciated that other joining methods/structures are also possible other than a spline. For example, male/female fittings with any shape (hex, square, etc.) could alternatively be employed among other options. Responsive to actuation of the trigger 114, the power source 112 may turn the spline portion, which turning may then be translated to the driveshaft 130 (via the spline portion of the driveshaft 130).

The driveshaft 130 may then communicate the drive power provided from the power head 110 to the cutting attachment 120. In this regard, for example, the cutting attachment 120 may include a coupling shaft 122. The coupling shaft 122 may include a spline portion (e.g., having a male fitting) that could couple the coupling shaft 122 to the driveshaft 130 as described in greater detail below. The spline portion of the coupling shaft 122 may turn and thereby power through saw body 124 to turn a cutting chain about guide bar 126. The saw body 124 may include an oil reservoir for enabling the guide bar, sprocket and/or other components of the saw body 124 to be lubricated.

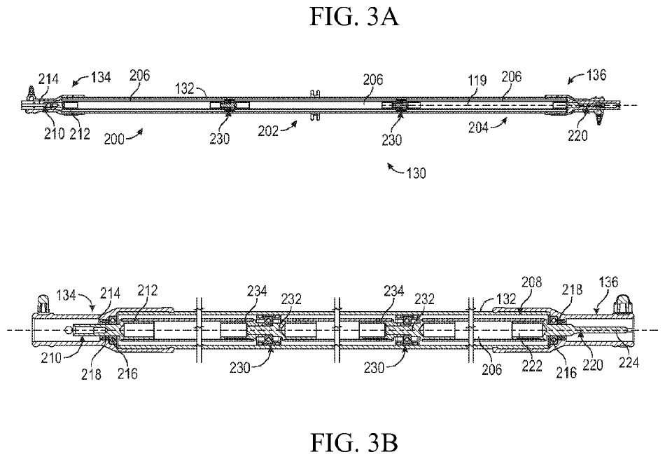

The driveshaft 130 may include an external housing 132 that may extend between a first coupler 134 and a second coupler 136. The first coupler 134 and the second coupler 136 may each include the corresponding spline portions mentioned above (see elements 210 and 220 in FIG. 3A), and may be configured to mate with the coupler 118 of the power head 110 and the coupling shaft 122 of the cutting attachment 120, respectively. The first and second couplers 134 and 136 may be configured for tool-less attachment to the coupler 118 of the power head 110 and the coupling shaft 122 of the cutting attachment 120, respectively. Thus, for example, a wing knob or other threaded fastener, which can be operated by hand only, and without any need for tools, may be provided at one or both of the first and second couplers 134 and 136. However, in some cases, a tool may be employed to operate the first and second couplers 134 and 136.

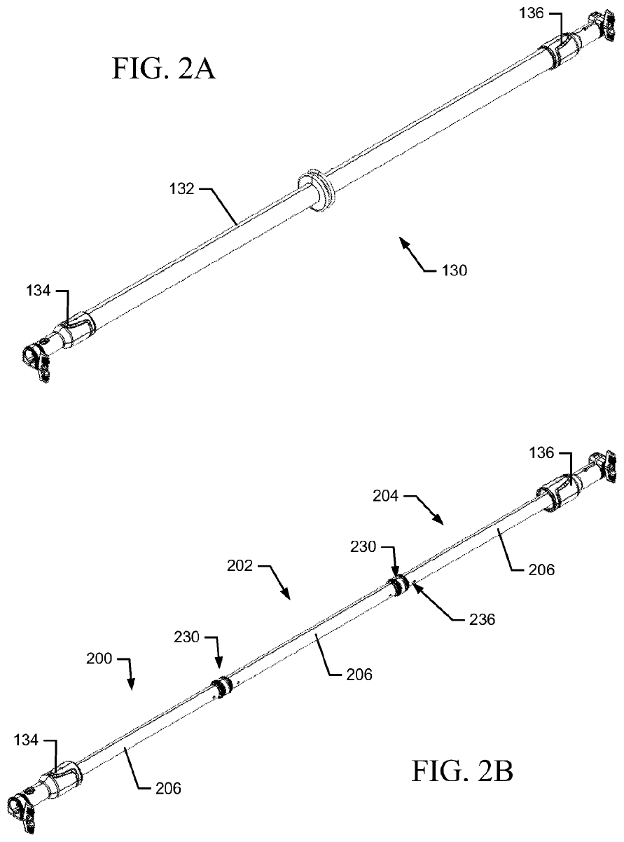

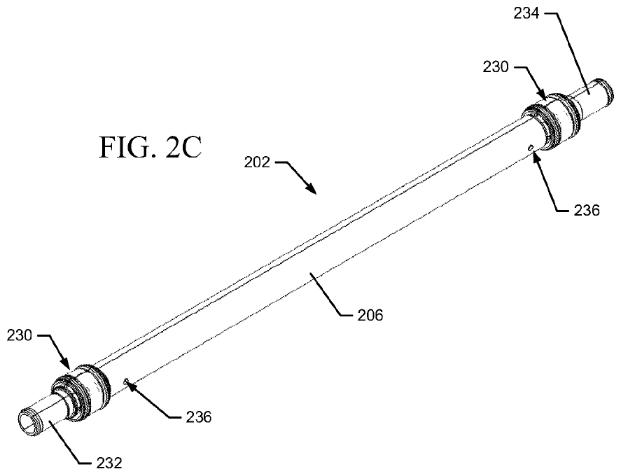

A perspective view of the driveshaft 130 is shown in isolation in FIG. 2A. Meanwhile, in FIG. 2B, the external housing 132 is removed in order to expose internal components of the driveshaft 130. In this regard, FIG. 2B shows multiple segments (e.g., a first segment 200, a second segment 202 and a third segment 204) that may be used to form the internal rotary shaft of the driveshaft 130, via which rotary power is actually transferred between the power head 110 and the cutting attachment 120. However, more or fewer than three segments (of equal or unequal lengths) may be used in alternative embodiments. FIG. 2C shows one segment (i.e., the second segment 202) in isolation along with portions of segment couplers that are used to operably couple the first segment 200 to the second segment 202, and the second segment 202 to the third segment 204, respectively. Each of the first, second and third segments 200, 202 and 204 may include a segment shaft body 206. Each of the segment shaft bodies 206 may be a substantially hollow, cylindrical tube that is made of non-conductive material (e.g., fiberglass). However, shapes other than cylindrical tubes may alternatively be employed. Notably, an air gap 208 (see FIG. 3B) may exist outside of each of the segment shaft bodies 206 between the segment shaft body 206 and the external housing 132. The air gap 208 may enable the first, second and third segments 200, 202 and 204 to freely turn within the external housing 132 without any contact therebetween.

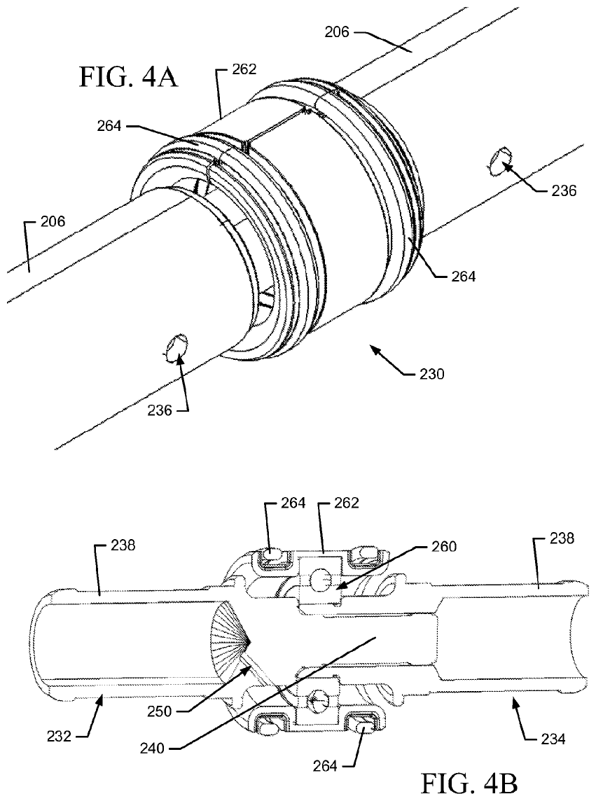

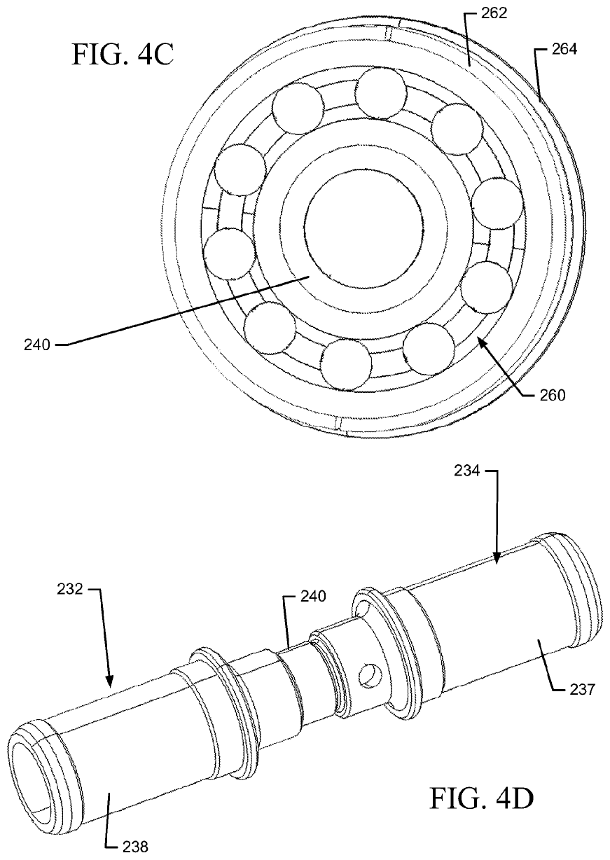

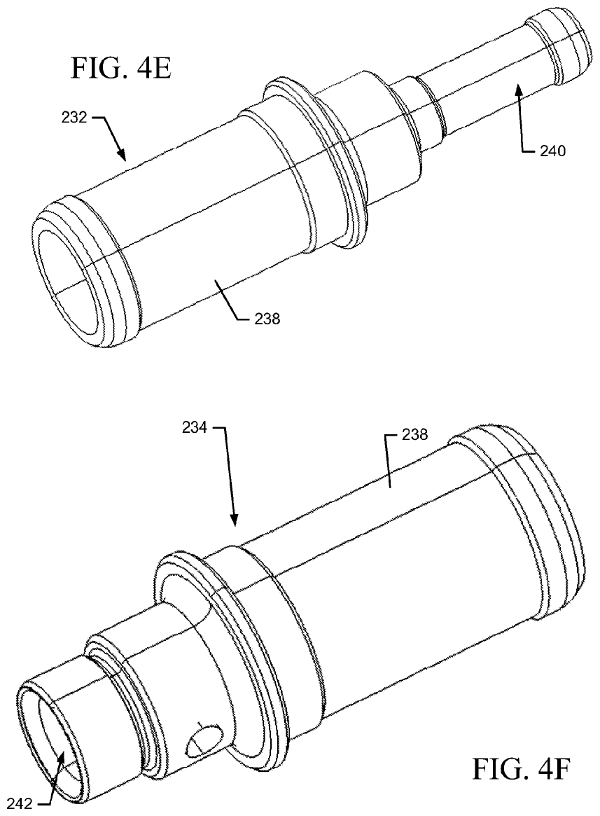

FIG. 3, which is defined by FIGS. 3A and 3B, illustrate cross section views of the driveshaft 130 taken along a plane passing through the longitudinal axis 119 of FIG. 1. FIG. 3A shows a full cross section view of the driveshaft 130. Meanwhile, in FIG. 3B, some portions are removed in order to enable a closer view of the internal components of the driveshaft 130. FIG. 4, which is defined by FIGS. 4A, 4B, 4C, 4D, 4E and 4F, shows various additional views of the internal components of the driveshaft 130.

Referring now primarily to FIGS. 2-4, it can be appreciated that the external housing 132 of the driveshaft 130 may be a continuous hollow, cylindrical tube that extends between the first and second couplers 134 and 136. That said, non-continuous tubes may be used in alternative embodiments. In an example embodiment, the external housing 132 may be made of fiberglass or another non-conductive material. Furthermore, the external housing 132 is fixed to each of the first and second couplers 134 and 136 (and therefore does not rotate). The first and second couplers 134 and 136 may each have cylindrical and hollow receiver portions inside which respective opposing ends of the external housing 132 may be disposed (and fixed). In some cases, the opposing ends of the external housing 132 may be fixed to the receiver portions of the first and second couplers 134 and 136, respectively, with fasteners. However, friction fittings, adhesives or other fixing means may be used in alternative embodiments.

As shown in FIG. 3, the first coupler 134 may house a female spline member 210 of the first segment 200. Meanwhile, the second coupler 136 may include a male spline member 220 of the third segment 204. However, it should be appreciated that the male/female arrangements could be reversed dependent upon the structures of the power head 110 and the cutting attachment 120. The male and female spline members 210 and 220 may each be made of metallic materials or other such strong materials.

The female spline member 210 may include a cup portion 212 and a shaft portion 214. The female fitting may be disposed at the distal end of the shaft portion 214. The cup portion 212 may be a substantially hollow, cylindrical portion that has an external diameter that is slightly smaller than an internal diameter of the segment shaft body 206. The segment shaft body 206 and the cup portion 212 may then be affixed to each other via friction fitting, adhesive, and/or one or more fasteners. In some cases, a combination of a press fit and epoxy may be used to fix the segment shaft body 206 and the cup portion 212 together.

In an example embodiment, the shaft portion 214 may have a smaller diameter than the cup portion 212. The transition between the shaft portion 212 and the cup portion 214 may therefore also be a location at which the female spline member 210 interfaces with the first coupler 134. In this regard, for example, the first coupler 134 may also transition in diameter proximate to the interface with the female spline member 210, and the first coupler 134 may include a bearing assembly 216 and a shaft seal 218 (e.g., a swiping shaft seal) that rotatably support the female spline member 210 within the first coupler 134.

The male spline member 220 may similarly include a cup portion 222 and a shaft portion 224. The male fitting may be disposed at the distal end of the shaft portion 224. The cup portion 222 may be a substantially hollow, cylindrical portion that has an external diameter that is slightly smaller than an internal diameter of the segment shaft body 206. The segment shaft body 206 and the cup portion 222 may then be affixed to each other via friction fitting, adhesive, and/or one or more fasteners (e.g., a combination of a press fit and epoxy).

In an example embodiment, the shaft portion 224 may have a smaller diameter than the cup portion 222. The transition between the shaft portion 222 and the cup portion 224 may therefore also be a location at which the male spline member 220 interfaces with the second coupler 136. In this regard, for example, the second coupler 136 may also transition in diameter proximate to the interface with the male spline member 220, and the second coupler 136 may include a bearing assembly 226 and a shaft seal 228 (e.g., a swiping shaft seal) that rotatably support the male spline member 220 within the second coupler 136.

The segment shaft body 206 of the first segment 200 and the segment shaft body 206 of the third segment 204 may extend toward each other to engage respective segment couplers 230 that operably couple the first and third segments 200 and 204 to the opposing respective ends of the second segment 202. FIG. 2C illustrates the second segment 202 and the segment couplers 230 on each opposing end thereof. Portions of the segment couplers 230 are shown in greater detail in FIG. 4.

In an example embodiment, each of the segment couplers 230 may include a first body engagement portion 232 and a second body engagement portion 234. The first and second body engagement portions 232 and 234 may be structured substantially similarly to the cup portions 212 and 222 described above (e.g., they may each be made of metallic materials). Moreover, each of the first and second body engagement portions 232 and 234 may be operably coupled to ends of respective instances of the segment shaft body 206 in a similar manner to how the cup portions 212 and 222 are connected to the segment shaft body 206 as described above. For example, orifices 236 formed in the segment shaft body 206 may enable epoxy to be inserted between the first and second body engagement portions 232 and 234 and corresponding portions of the segment shaft body 206. More specifically, the first and second body engagement portions 232 and 234 may each include a cup portion 238 similar to the cup portions 212 and 222 described above.

As shown in FIGS. 4E and 4F, the first body engagement portion 232 may include a shaft 240, which may extend into a corresponding receiver 242 of the second body engagement portion 234. In some cases, the shaft 240 and receiver 242 may each have a hex, star or other unique corresponding shape configuration to enable the shaft 240 to socket into the receiver 242. However, other coupling strategies may alternatively be employed. For example, any combination or friction fitting, adhesives, fasteners, etc., may be employed to affix the first body engagement portion 232 to the second body engagement portion 234. In an example embodiment, the cup portions 238 of the first and second body engagement portions 232 and 234 may be disposed opposite either the shaft 240 or the receiver 242, respectively.

In some examples, one or both of the first and second body engagement portions 232 and 234 may include a vent 250 (see FIG. 4B). The vent 250 may extend from inside the first and second body engagement portions 232 and 234 to a portion outside thereof. As such, the area inside each of the first, second and third segments 200, 202 and 204 may be vented to the air gap 208. By venting the inside to the outside of the first, second and third segments 200, 202 and 204, any trapped pressure or gasses that may otherwise build up in any or each of the segments may be released.

The segment couplers 230 may also include a bearing assembly 260, which may be supported between respective ones of the first, second and third segments 200, 202 and 204 by a carrier assembly 262. The carrier assembly 262 of some examples may be a plastic or other non-conductive structure comprised of two case halves, which may be held together by one or more rubber o-rings 264. In this example, the carrier assembly 262 has an external diameter that is slightly smaller than an internal diameter of the external housing 132. Thus, particularly when the o-rings 264 are in place, the o-rings 264 and the carrier assembly 262 may both engage the inside of the external housing 132 to rotatably support the first and second body engagement portions 232 and 234, and divide the air gap 208 into respective parts that correspond to the first, second and third segments 200, 202 and 204.

The carrier assembly 262 may be structured to retain the bearing assembly 260 in a fixed location, and the bearing assembly 260 may further interface with one or both of the first and second body engagement portions 232 and 234 to rotatably support the first and second body engagement portions 232 and 234. As shown in FIGS. 4B and 4C, which are cross sections along the axis 219 and perpendicular to the axis 219, respectively, the bearing assembly 260 may include ball bearings disposed between inner and outer rings. Accordingly, the first and second body engagement portions 232 and 234 may rotate with the inner ring while the outer ring may remain fixed with the carrier assembly 262 and the external housing 132.

As can be appreciated from the descriptions above, the power head 110 is operably coupled to one of the female spline member 210 or the male spline member 220, and the cutting attachment 120 is operably coupled to the other of the male spline member 220 or the female spline member 210. Meanwhile, the driveshaft 130 is structured so that the entirety of the external housing 132 is both fixed and non-conductive (e.g., dielectric), while the first, second and third segments 200, 202 and 204 are operably coupled to the female spline member 210 or the male spline member 220 to rotate therewith inside the external housing 132. In this regard, for example, the segment shaft body 206 of each of the first, second and third segments 200, 202 and 204 is rigidly and fixedly coupled to respective ones of the female spline member 210, the male spline member 220, and the segment couplers 230 to create a continuous shaft that rotates responsive to power application from the power head 110.

In accordance with this example, the power head 110 rotates the female spline member 210, which in turn rotates the segment shaft body 206 of the first segment 200, which is rigidly coupled thereto. The segment shaft body 206 of the first segment 200 is rigidly coupled to the segment coupler 230 disposed between the first and second segments 200 and 202 and thereby rotates the segment shaft body 206 of the second segment 202, which is rigidly coupled to the segment coupler 230. The segment shaft body 206 of the second segment 202 is then rigidly coupled to the segment coupler 230 disposed between the second and third segments 202 and thereby rotates the segment shaft body 206 of the third segment 204, which is rigidly coupled to the segment coupler 230. The segment shaft body 206 of the third segment 204 is then also rigidly coupled to the male spline member 220, which is operably coupled to the cutting attachment 120.

Although the female spline member 210, the male spline member 220, and the segment couplers 230 may each include metallic materials, none of these components contact each other. Moreover, the only components connecting the female spline member 210, the male spline member 220, and the segment couplers 230 (i.e., primarily the segment shaft body 206 of each respective segment) are non-metallic and therefore dielectric or insulating. Thus, while the driveshaft 130 includes a continuous mechanical connection from the power head 110 to the cutting attachment 120, any potential path for electrical connection between the power head 110 and the cutting attachment 120 is substantially insulated. Example embodiments therefore provide a rugged and fully functional driveshaft 130 that operably couples rotating power efficiently, while also providing full electrical isolation between the power head 110 and the cutting attachment 120. Any inadvertent contact of the cutting attachment 120 with electrical wires or some other power source could then not be transmitted through the driveshaft 130 to the operator.

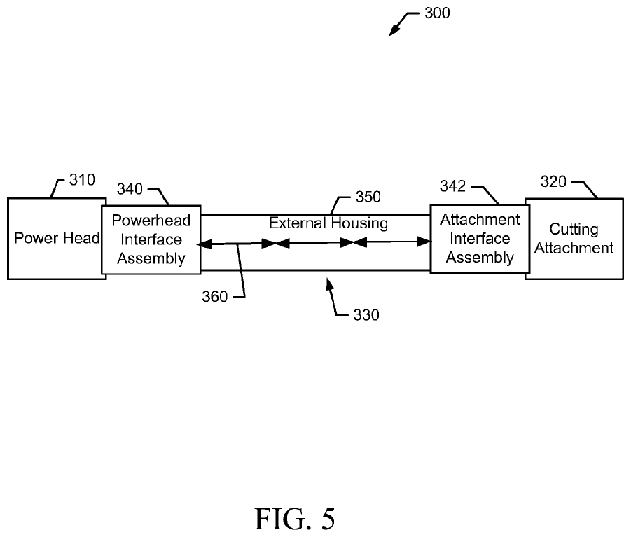

As noted above, the specific structures described in reference to FIGS. 1-4 are all examples of one embodiment. However, other example embodiments may employ other specific structures. As such, FIG. 5 is provided to illustrate a block diagram of a piece of outdoor power equipment 300 that may be configured in accordance with example embodiments of the present invention. In this regard, the outdoor power equipment 300 driveshaft for outdoor power equipment may include a power head 310 and a cutting attachment 320 that are operably coupled together via a driveshaft 330 (e.g., a dielectric or insulated driveshaft). The driveshaft 330 may include a power head interface assembly 340 configured to operably couple the driveshaft 330 to the power head 310. The driveshaft 330 may also include an attachment interface assembly 342 configured to operably couple the driveshaft 330 to the cutting attachment 320. The driveshaft 330 may also include an external housing 350 rigidly coupling the power head 310 to the cutting attachment 320 (e.g., via a fixed portion of the power head interface assembly 340 and the attachment interface assembly 342). The driveshaft 330 may also include a segmented internal drive assembly 360 configured to provide mechanical communication of rotary power from the power head 310 to the cutting attachment 320 (e.g., via a movable portion of the power head interface assembly 340 and the attachment interface assembly 342). The segmented internal drive assembly 360 includes individually electrically insulated segments.

Accordingly, in one example embodiment, a driveshaft for outdoor power equipment may be provided. The driveshaft may include a power head interface assembly configured to operably couple the driveshaft to a power head of the outdoor power equipment, an attachment interface assembly configured to operably couple the driveshaft to a cutting attachment of the outdoor power equipment, an external casing rigidly coupling the power head interface assembly to the attachment interface assembly, and a segmented internal drive assembly configured to provide mechanical communication of mechanical power from the power head to the cutting attachment. The segmented internal drive assembly may include individually electrically insulated segments.

In some cases, modifications or amplifications may further be employed as optional alterations or augmentations to the description above. These alterations or augmentations may be performed exclusive of one another or in any combination with each other. In some cases, such modifications or amplifications may include each of the individually insulated segments including a segment shaft body made of non-metallic, insulating material and a segment coupler configured to couple a first segment shaft body of one segment to a second segment shaft body of an adjacent segment. In an example embodiment, the segment shaft body and the external housing may each be made of fiberglass, and the segment coupler may include metallic materials. In some examples, the segment coupler may include a bearing assembly and a carrier assembly. The carrier assembly may support the bearing assembly proximate to the segment coupler. In an example embodiment, the carrier assembly may include a non-conductive material and one or more o-rings to affix the carrier assembly inside the external housing. In some examples, the segment coupler may be vented from an internal portion of the segmented internal drive assembly to an external portion of the segmented internal drive assembly. In an example embodiment, an air gap may be disposed between the external housing and the segment shaft body of each of the individually electrically insulated segments. In some examples, the segmented internal drive assembly may include a first insulated segment, a second insulated segment and a third insulated segment. The first insulated segment may include the first segment shaft body, the second insulated segment may include the second segment shaft body, and the third insulated segment may include a third segment shaft body. The segment coupler may couple the first segment shaft body to the second segment shaft body, and a second segment coupler may couple the second segment shaft body to the third segment shaft body. The first, second and third segment shaft bodies may turn with each other independent of the external housing. In an example embodiment, the attachment interface assembly and the power head interface assembly may each include a bearing assembly and a shaft seal. In some examples, the attachment interface assembly and the power head interface assembly may each be configured for attachment to the cutting attachment and the power head, respectively, without tools. In an example embodiment, the cutting attachment may be one of a plurality of different interchangeable cutting attachments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A driveshaft for outdoor power equipment, the driveshaft comprising:
a power head interface assembly configured to operably couple the driveshaft to a power head of the outdoor power equipment;
an attachment interface assembly configured to operably couple the driveshaft to a cutting attachment of the outdoor power equipment
an external housing rigidly coupling the power head to the cutting attachment, the external housing being made of an insulating material; and
a segmented internal drive assembly configured to provide mechanical communication of rotary power from the power head to the cutting attachment,
wherein the segmented internal drive assembly comprises individually electrically insulated segments.

2. The driveshaft of claim 1, wherein each of the individually insulated segments comprises a segment shaft body made of non-metallic, insulating material and a segment coupler configured to couple a first segment shaft body of one segment to a second segment shaft body of an adjacent segment.

3. The driveshaft of claim 2, wherein the segment shaft body and the external housing are each made of fiberglass, and
wherein the segment coupler includes metallic materials.

4. The driveshaft of claim 2, wherein the segment coupler comprises a bearing assembly and a carrier assembly, the carrier assembly supporting the bearing assembly proximate to the segment coupler.

5. The driveshaft of claim 4, wherein the carrier assembly comprises a non-conductive material and one or more elastomeric components to affix the carrier assembly inside the external housing.

6. The driveshaft of 2, wherein the segment coupler is vented from an internal portion of the segmented internal drive assembly to an external portion of the segmented internal drive assembly.

7. The driveshaft of claim 2, wherein an air gap is disposed between the external housing and the segment shaft body of each of the individually electrically insulated segments.

8. The driveshaft of claim 2, wherein the segmented internal drive assembly comprises a first insulated segment, a second insulated segment and a third insulated segment,
wherein the first insulated segment comprises the first segment shaft body, the second insulated segment comprises the second segment shaft body, and the third insulated segment comprises a third segment shaft body,
wherein the segment coupler couples the first segment shaft body to the second segment shaft body, and a second segment coupler couples the second segment shaft body to the third segment shaft body, and
wherein the first, second and third segment shaft bodies turn with each other independent of the external housing.

9. The driveshaft of claim 1, wherein the attachment interface assembly and the power head interface assembly each include a bearing assembly and a shaft seal.

10. The driveshaft of claim 1, wherein the attachment interface assembly and the power head interface assembly are each configured for attachment to the cutting attachment and the power head, respectively, without tools.

11. An outdoor power equipment device comprising:
a power head;
a cutting attachment; and
a driveshaft operably coupling the power head to the cutting attachment, the driveshaft comprising:
a power head interface assembly configured to operably couple the driveshaft to the power head;
an attachment interface assembly configured to operably couple the driveshaft to the cutting attachment;
an external housing rigidly coupling the power head to the cutting attachment, the external housing being made of an insulating material; and
a segmented internal drive assembly configured to provide mechanical communication of rotary power from the power head to the cutting attachment,
wherein the segmented internal drive assembly comprises individually electrically insulated segments.

12. The device of claim 11, wherein each of the individually insulated segments comprises a segment shaft body made of non-metallic, insulating material and a segment coupler configured to couple a first segment shaft body of one segment to a second segment shaft body of an adjacent segment.

13. The device of claim 12, wherein the segment shaft body (and the external housing are each made of fiberglass, and
wherein the segment coupler includes metallic materials.

14. The device of claim 12, wherein the segment coupler comprises a bearing assembly and a carrier assembly, the carrier assembly supporting the bearing assembly proximate to the segment coupler.

15. The device of claim 12, wherein the segment coupler is vented from an internal portion of the segmented internal drive assembly to an external portion of the segmented internal drive assembly.

16. The device of claim 12, wherein an air gap is disposed between the external housing and the segment shaft body of each of the individually electrically insulated segments.

17. The device of claim 12, wherein the segmented internal drive assembly comprises a first insulated segment, a second insulated segment and a third insulated segment,
wherein the first insulated segment comprises the first segment shaft body, the second insulated segment comprises the second segment shaft body, and the third insulated segment comprises a third segment shaft body,
wherein the segment coupler couples the first segment shaft body to the second segment shaft body, and a second segment coupler couples the second segment shaft body to the third segment shaft body, and
wherein the first, second and third segment shaft bodies turn with each other independent of the external housing.

18. The device of claim 11, wherein the attachment interface assembly and the power head interface assembly each include a bearing assembly and a shaft seal.

19. The device of claim 11, wherein the attachment interface assembly and the power head interface assembly are each configured for attachment to the cutting attachment and the power head, respectively, without tools.

20. The device of claim 11, wherein the cutting attachment is one of a plurality of different interchangeable cutting attachments.
